(19) United States
(12) Patent Application Publication
(10) Pub. No.: US 2012/0194520 A1
(43) Pub. Date: Aug. 2, 2012

(54) PRESENTATION MODES FOR RADIO NETWORK MEASUREMENTS

(75) Inventors: Johan Erik Magnus Nordfelth, (US); Michael Sven Anders Carlberg Lax, (US)

(73) Assignee: Ascom Network Testing Inc.

(21) Appl. No.: 13/018,157

(22) Filed: Jan. 31, 2011

(51) Int. Cl. G06T 11/20

(52) U.S. Cl. 345/440

(57) ABSTRACT

Various methods, systems, and computer program products are disclosed for. One or more values associated with one or more attributes of a serving cell associated with a user equipment or at least two network cells being tracked by the user equipment may be determined. One or more portions of a serving cell pie-view display may be allocated based on the measured one or more values associated with the serving cell and the serving cell pie-view display may be generated based on the allocated one or more portions. One or more portions of an available cell pie-view display may be allocated based on the measured one or more values associated with the at least two network cells and the available cell pie-view display may be generated based on the allocated one or more portions.

### FIELD OF THE INVENTION

The disclosure relates to providing presentation modes/views related to network cell measurements and in particular to providing presentation modes/views that provide visualization of the measurements relative to each other.

### BACKGROUND OF THE INVENTION

Conventional network RF (radio frequency) engineering tools display measurements related to a mobile network cell or set of mobile network cells using tables or line charts. When using a table, each row of the table represents a cell and each column of the table represents a measurement related to the cell. When using a line chart, each line of the chart represents a measurement related to a cell or a set of cells.

Although possible to display information using a table and visualize temporal variation in measurements using a line chart, these visualization mechanisms suffer from drawbacks. For example, these and other conventional mechanisms fail to provide a quick overview of the RF environment and how good each cell is in relation to the other cells. This is because conventional mechanisms typically illustrate absolute values of the measurements, and not how good a measured value is in relation to other values.

What is needed is a system and method of visualizing performance of one or more network cells relative to one another and/or measurement values related to a network cell relative to one another. These and other problems exist.

### SUMMARY OF THE INVENTION

Various systems, computer program products, and methods of visualizing performance of one or more network cells and/or measurements related to the network cells relative to one another are described herein.

According to various implementations of the invention, the method may include determining a first value of a first network cell and a second value of a second network cell, wherein the first and second values are based on measurements of a first attribute that indicates performance of the first and second network cells. The method may include allocating a first portion of an available cell pie-view display to be occupied based on the first value and a second portion of the available cell pie-view display to be occupied based on the second value, wherein the available cell pie-view display comprises a substantially circular display having a total angle of 360 degrees and a display radius, and wherein the first portion is based on the first value and the total angle and the second portion is based on the second value and the total angle. The method may include determining a third value of the first network cell and a fourth value of the second network cell, wherein the third and fourth values are based on measurements of a second attribute that indicates performance of the first and second network cells, wherein the second attribute is different than the first attribute. The method may include determining a first radius based on the third value and the display radius and a second radius based on the fourth value and the display radius. The method may include allocating a third portion of the available cell pie-view display to be occupied based on the first radius and the first portion and a fourth portion of the available cell pie-view display to be occupied based on the second radius and the second portion, wherein the third portion overlaps the first portion and the fourth portion overlaps the second portion, and wherein the first, second, third and fourth portions provide visualization of measurements of the first and second network cells relative to each other.

According to various implementations of the invention, the method may include receiving a first value associated with a user equipment, a second value associated with a network cell being tracked by the user equipment, and a third value associated with a carrier of the network cell. The method may include allocating an inner circle region of a pie-view representing a value for one of: the user equipment, the network cell, or the carrier, wherein the pie-view display comprises a substantially circular display having a total angle of 360 degrees. The method may include allocating a middle circle region of the pie-view representing a value for one of: the user equipment, the network cell, or the carrier not displayed in the inner circle. The method may include allocating an outer circle region of the pie-view representing a value for one of: the user equipment, the network cell, or the carrier not displayed in the inner circle region and the middle circle region, wherein the inner circle region, the middle circle region, and the outer circle region are configured to collectively represent the first, second, and third values.

According to various implementations of the invention, the method may include determining first and second values of the serving cell, wherein the first and second values are based on measurements of first and second attributes of the serving cell. The method may include allocating an inner circle portion of a serving cell pie-view display for the first value, wherein the inner circle portion is substantially circular having a total angle of 360 degrees, wherein the serving cell pie-view display comprises the inner circle portion. The method may include determining a first angle for the second value and determining a first radius, wherein the first angle is based on the second value. The method may include allocating a first portion of the serving cell pie-view display based on the first angle and the first radius. The method may include determining a third value of the UE, wherein the third value is based on a measurement of a UE attribute. The method may include determining a second angle for the third value and determining a second radius, wherein the second angle is based on the third value. The method may include allocating a second portion of the serving cell pie-view display based on the second angle and the second radius.

### BRIEF DESCRIPTION OF THE DRAWINGS

FIG. 1 is a block diagram illustrating a system of visualizing performance of one or more network cells and/or measurements related to the network cells relative to one another, according to various implementations of the invention.

FIGS. 2A and 2B are diagrams depicting exemplary presentation modes/views for visualizing performance of a serving cell, according to various implementations of the invention.

FIG. 3 is a diagram illustrating a screen shot of an exemplary presentation mode/view for visualizing performance of a serving cell, according to various implementations of the invention.

FIGS. 4A and 4B are diagrams depicting exemplary presentation modes/views for visualizing performance of network cells relative to one another, according to various implementations of the invention.

FIG. 5 is a diagram illustrating a screenshot of an exemplary presentation mode/view for visualizing performance of network cells relative to one another, according to various implementations of the invention.

FIG. 6 is a diagram depicting an exemplary presentation mode/view for visualizing performance of network cells relative to one another, according to various implementations of the invention.

FIG. 7 is a diagram illustrating an exemplary presentation mode/view for visualizing network cells of different radio access technologies relative to one another during a compressed mode for potential handover, according to various implementations of the invention.

FIG. 8 is a diagram illustrating a generic presentation mechanism, according to various implementations of the invention.

FIG. 9 is a flow diagram illustrating an example process of visualizing performance of one or more network cells relative to one another, according to various implementations of the invention.

FIG. 10 is a flow diagram illustrating an example process of visualizing different components of a communications network, the components comprising user equipment, network cells, and carriers of the network cells, according to various implementations of the invention.

FIG. 11 is a flow diagram illustrating an example process of visualizing performance of a serving cell in relation to a user equipment being served by the serving cell, according to various implementations of the invention

FIGS. 12A-12E are diagrams depicting exemplary regions and/or portions of FIG. 4A, according to various implementations of the invention.

### DETAILED DESCRIPTION OF THE INVENTION

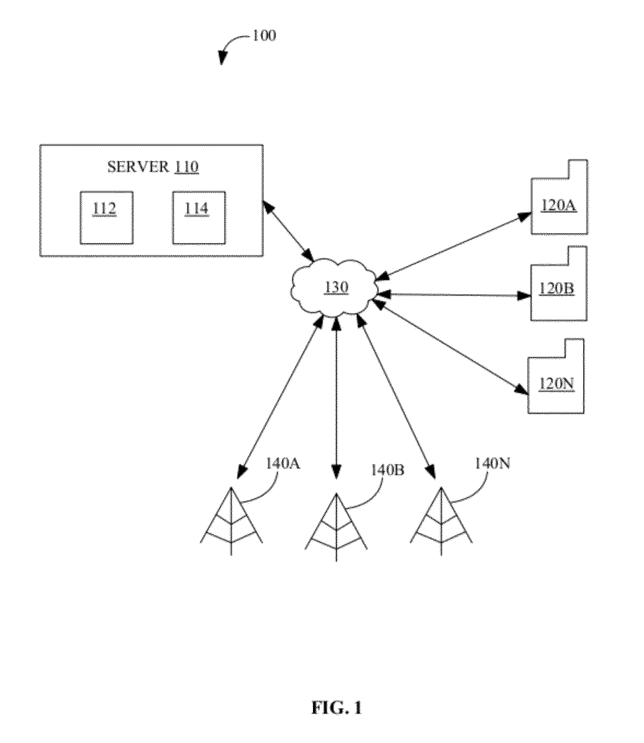

FIG. 1 is a block diagram illustrating a system 100 of visualizing performance of one or more network cells and/or measurements related to the network cells relative to one another, according to various implementations of the invention. In some implementations, system 100 may be used to visualize measurements associated with user equipments 120. In some implementations, the measurements may be dependent on user equipments 120 and may not be affected or influenced by other entities of system 100. In some implementations, the measurements may include measurements related to battery performance, and/or other measurements. In some implementations, the measurements may be performed in the software/hardware protocol stacks or interfaces. In some implementations, system 100 may be used to visualize performance measurements between various entities of system 100, for example, between user equipments 120 and base stations 140, and between user equipments 120 and server 110. In some implementations, the performance measurements between user equipments 120 and base stations 140 may include a measurement of Ec/N0, for example. In some implementations, system 100 may be used to visualize measurements that vary over time.

According to various implementations of the invention, system 100 may include, for example, user equipments 120 (illustrated in FIG. 1 as user equipment 120A, 120B, . . . , 120N), base stations 140 (illustrated in FIG. 1 as base station 140A, 140B, . . . , 140N), a communications network 130, and a server 110. In some implementations, user equipments 120, base stations 140, and server 110 may be communicably coupled to one another via communications network 130, which may be at least partially formed from base stations 140. Communications network 130 may include a Local Area Network, a Wide Area Network, a mobile communications network (for example GSM, CDMA, WCDMA, etc.), a Public Switched Telephone Network, and/or other network or combination of networks. As would be appreciated, each base station 140 may be responsible for one or more network cells (not illustrated in FIG. 1). In some implementations, user equipments 120 may include a laptop computer, a tablet computer, a cellular phone, or other device configured to operate on communications network 130.

In some implementations, user equipment 120 may monitor various aspects of communications network 130 such as an RF environment. In some implementations, user equipment 120 may collect measurements related to a serving cell that is currently serving user equipment 120. In some implementations, user equipment 120 may collect measurements related to network cells that user equipment 120 is currently tracking.

In some implementations, user equipment 120 may collect the measurements for immediate processing and visualization by user equipment 120. In these implementations, the visualization may be displayed by user equipment 120 and/or communicated to a remote device such as server 110. In some implementations, user equipment 120 may collect the measurements for processing at a later time by other components of system 100, such as server 110. For example, in some implementations, user equipment 120 may communicate the measurements to server 110 for processing. In some implementations, user equipment 120 may be operated by a user to monitor and visualize at least a portion of communications network 130. In other implementations, user equipment 120 may be operated by a remote device such as server 110 to monitor and visualize at least a portion of communications network 130.

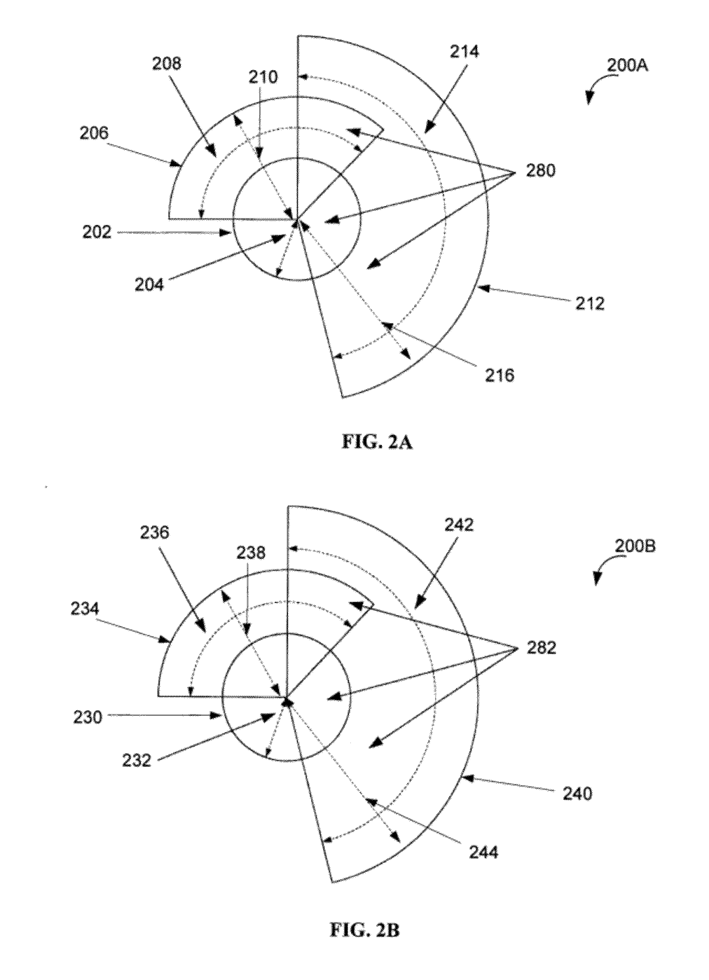

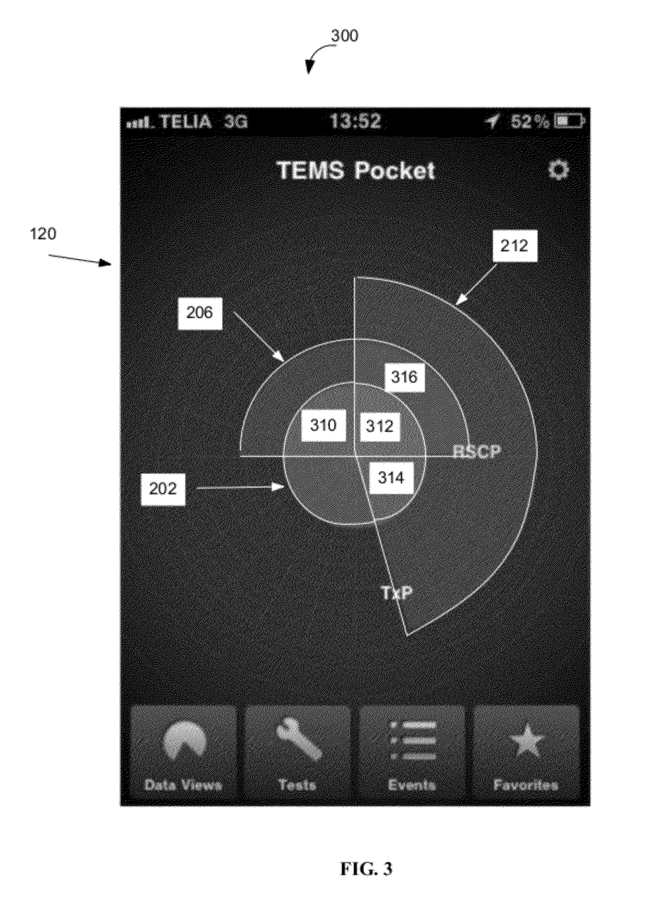

In some implementations, user equipment 120 may generate a serving cell pie view display illustrated by various implementations 200A and 200B of respective FIGS. 2A and 2B. With respect to the serving cell pie view display, reference will be made to FIGS. 2A and 2B for the purpose of illustration and not limitation. In some implementations, user equipment 120 may measure or otherwise determine one or more values associated with one or more attributes of a serving cell, i.e., the network cell that is currently serving user equipment 120. In some implementations, the attributes may include a measurable characteristic of the serving cell.

In some implementations, different radio access technologies may include attributes that are different from one another. Accordingly, different displays may be generated for different types of radio access technologies. In some implementations, for example, WCDMA technology may include various attributes such as Ec/N0 (received energy per chip divided by the power density in the band) of the serving cell, RSCP (received signal code power, i.e., power received from one WCDMA cell), UTRI Carrier RSSI, scrambling code information, UARFCN (UTRA Absolute Radio Frequency Channel Number), other attributes specific to WCDMA, and/or attributes common to different types of technologies. An example of a serving cell pie-view display for WCDMA technology is illustrated in FIG. 2A. In some implementations, GSM technology may include path-loss criterion C1 of the serving cell, RxLev (received signal level) of the serving cell, band name information, ARFCN (Absolute Radio Frequency Channel Number), other attributes specific to GSM, and/or attributes common to different types of technologies. An example of a serving cell pie-view display for GSM technology is illustrated in FIG. 2B.

In some implementations, user equipment 120 may determine values of one or more attributes associated with user equipment 120. For example, the one or more attributes may include a transmit power of user equipment 120. In some implementations, the one or more attributes may include hardware properties such as battery power, temperature, number of key presses, number of running applications, memory usage, CPU load, and/or other properties. In some implementations, the hardware properties may include properties associated with other devices physically connected to user equipment 120, for example, memory cards, positioning devices, and/or other devices.

In some implementations, user equipment 120 may allocate one or more portions (illustrated in FIG. 2A as portions 202, 206, and 212; and illustrated in FIG. 2B as portions 230, 234, 240) of a serving cell pie-view display based on the measured one or more values. In some implementations, user equipment 120 may generate the serving cell pie-view display based on the allocated one or more portions (202, 206, 212; and 230, 234, 240). In some implementations, the measurements associated with the attributes of the serving cell may be depicted both geometrically and by color in the serving cell pie-view display, thereby providing a quick overview of the radio environment and an indication of how good a measured value is in relation to other values.

In some implementations, user equipment 120 may determine first and second values of the serving cell, wherein the first and second values may be based on measurements of first and second attributes of the serving cell. In some implementations, the determining may include receiving raw measurements associated with the first and second attributes from user equipment 120. In some implementations, user equipment 120 may determine the first and second values based on the received raw measurements. In some implementations, user equipment 120 may determine the first and second values by performing calculations on or other processing of the received raw measurements.

In some implementations, the first and second attributes of the serving cell may be based on a type of radio access technology being used by user equipment 120. For WCDMA technology (a serving cell pie-view display of which is illustrated in FIG. 2A), the first attribute may include Ec/N0 of the serving cell and the second attribute may include RSCP of the serving cell, for example. For GSM technology (a serving cell pie-view display of which is illustrated in FIG. 2B), the first attribute may include path-loss criterion C1 of the serving cell and the second attribute may include RxLev (received signal level) of the serving cell, for example. As would be appreciated, other types and combinations of attributes may be displayed by a serving cell pie-view display.

In some implementations, user equipment 120 may determine a third value associated with user equipment 120, wherein the third value may be based on a measurement of a UE attribute (i.e., attribute associated with user equipment 120). In some implementations, the determining may include receiving the third value from user equipment 120. In some implementations, the third attribute may include the transmit power used by user equipment 120.

In some implementations, user equipment 120 may allocate an inner circle portion (202, 230) of a serving cell pie-view display for the first value. In some implementations, the inner circle portion (202, 230) may be substantially circular having a total angle of 360 degrees. In some implementations, the inner circle portion (202, 230) may be placed substantially at a center of the serving cell pie-view display. In some implementations, the center of the inner circle portion (202, 230) may be substantially the center of the serving cell pie-view display. In some implementations, an inner radius (204, 232) of the inner circle portion (202, 230) may represent the first attribute (for example, Ec/N0 or C1) of the serving cell. In some implementations, the inner radius (204, 232) of the inner circle portion may be based on the first value associated with the first attribute. For example, the size of inner radius (204, 232) may be based on the size of the first value.

In some implementations, user equipment 120 may determine a first angle (208, 236) based on the second value and may determine a first radius (210, 238). In some implementations, the first angle (208, 236) may represent the second attribute (for example, RSCP or RxLev) of the serving cell. In some implementations, the first angle (208, 236) may be based on the second value associated with the second attribute. For example, the size of the first angle may be based on the second value. In some implementations, the first radius (210, 238) may be a constant or fixed value relative to a size of a screen associated with user equipment 120. In some implementations, user equipment 120 may allocate a first portion (206, 234) of the serving cell pie-view display based on the first angle (208, 236) and the first radius (210, 238).

In some implementations, user equipment 120 may determine a second angle (214, 242) for the third value and may determine a second radius (216, 244). In some implementations, the second angle (214, 242) may represent the third attribute (for example, transmit power) of user equipment 120. In some implementations, the second angle (214, 242) may be based on the third value associated with the third attribute. For example, larger transmit powers of user equipment 120 will result in larger second angles (214, 242). In some implementations, the second radius (216, 244) may be a constant or fixed value relative to a size of a screen associated with user equipment 120. In some implementations, the first radius and the second radius may have different values such that they can be distinguished from one another when depicted at user equipment 120. In some implementations, user equipment 120 may allocate a second portion (212, 240) of the serving cell pie-view display based on the second angle (214, 242) and the second radius (216, 244).

In some implementations, user equipment 120 may allocate a color for at least one of: the inner circle region (202, 230), the first portion (206, 234), or the second portion (212, 240) based on their respective first, second, or third values. For example, user equipment 120 may allocate a green color to a region/portion of the serving cell-pie view display to indicate a good value of the associated attribute. Similarly, user equipment 120 may allocate a red color to a region/portion of the serving cell-pie view display to indicate a poor value of the associated attribute. For instance, good Ec/N0 value for the serving cell may be indicated by allocating a green color to the inner circle region (202, 230). Similarly, a poor RSCP value for the serving cell or a poor transmit power associated with user equipment 120 may be indicated by allocating a red color to the first or second portions, respectively. In some implementations, different shades of colors (or spectrum from one color to another color) can represent varying degrees of a value such as large, medium, and small. As would be appreciated, different colors can have different meanings.

In some implementations, user equipment 120 may generate the serving cell pie-view display based on the inner circle region (202, 230), the first portion (206, 234), and the second portion (212, 240). In some implementations, the generating may include generating the serving cell pie-view display (i.e., the region/portions) with the allocated colors. As such, the serving cell pie-view display may depict the measurements associated with the attributes of the serving cell and/or user equipment 120 both geometrically and by color, thereby providing a quick overview of the radio environment and an indication of how good a measured value is in relation to other values. In some implementations, different radius/angle sizes may represent varying degrees of a value. For example, a bigger size may indicate a better value for a particular attribute than a worse value (such that the worse value will have a smaller size).

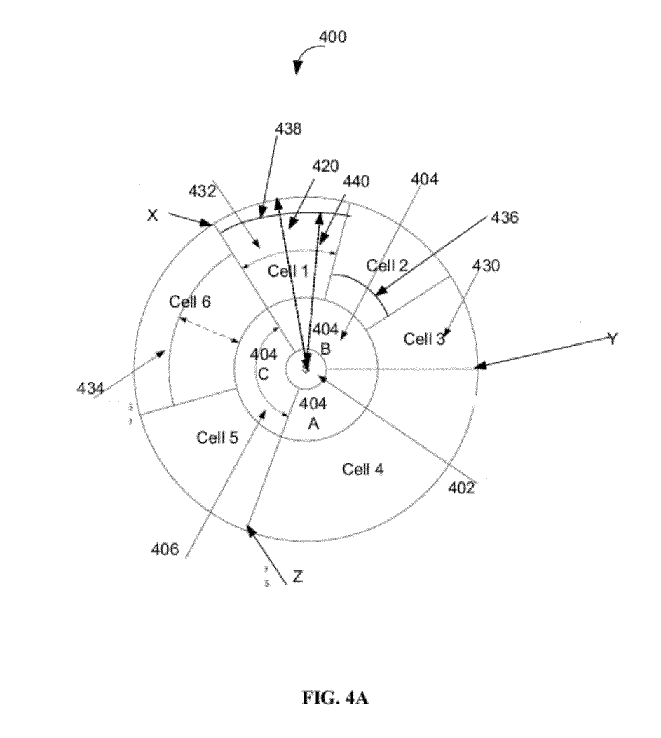

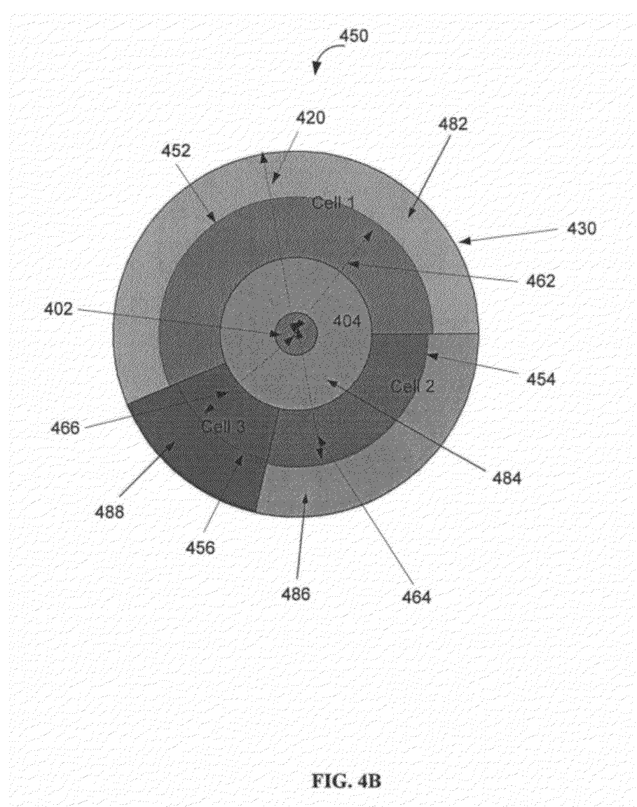

In some implementations, user equipment 120 may generate an available cell pie-view display, various implementations (400, 500, 600) of which are illustrated in FIGS. 4A, 5, and 6. With respect to generation of an available cell pie view display by user equipment 120, reference will be made to FIG. 4A for the purpose of illustration and not limitation. In some implementations, user equipment 120 may measure one or more values associated with one or more attributes of at least two network cells being tracked by user equipment 120. In some implementations, these attributes can include the attributes described above with respect to the serving cell pie view display. However, unlike the serving cell pie view display illustrated in FIGS. 2A and 2B, the available cell pie-view display visualizes more than one cell, which can include the serving cell and/or network cells that user equipment 120 is tracking.

In some implementations, user equipment 120 may allocate one or more portions (illustrated in FIG. 4A as “Cell 1”, “Cell 2”, . . . , “Cell 6”; hereinafter, collectively “portions 1 . . . 6” for convenience), of an available cell pie-view display based on the measured one or more values. In some implementations, user equipment 120 may generate the available cell pie-view display based on the allocated one or more portions 1 . . . 6, thereby providing visualizations of the measurements associated with the at least two cells relative to each other.

In some implementations, user equipment 120 may determine a first value of a first network cell 1 and a second value of a second network cell 2, wherein the first and second values may be based on measurements of a first attribute associated with or that otherwise indicates performance of the first and second network cells. For example, the first and second values may include Ec/No values for Cell 1 and Cell 2, respectively.

In some implementations, user equipment 120 may determine a third value of the first network cell 1 and a fourth value of the second network cell 2, wherein the third and fourth values may be based on measurements of a second attribute that indicates performance of the first and second network cells. In some implementations, the second attribute may be different than the first attribute. In this manner, different attributes of different cells may be simultaneously visualized.

In some implementations, the determining may include receiving raw measurements associated with the first attribute and/or second attribute from user equipment 120. In some implementations, user equipment 120 may determine the first, second, third, and fourth values based on the received raw measurements. In some implementations, user equipment 120 may determine the first, second, third, and fourth values by performing calculations or other processing on the received raw measurements, thereby generating the first, second, third, and fourth values.

In some implementations, user equipment 120 may allocate a first portion of an available cell pie-view display to be occupied based on the first value of the first network cell. In some implementations, the available cell pie-view display may include a substantially circular display having a total angle of 360 degrees and a display radius 420.

In some implementations, the first portion may be based on the first value and the total angle. In some implementations, user equipment 120 may allocate a second portion of the available cell pie-view display to be occupied based on the second value of the second network cell. In some implementations, the second portion may be based on the second value and the total angle. In this manner, the relative sizes of the first and second portions may be based on their respective values and the total angle. For example, a Cell 1 and Cell 2 may include an allocation based on their Ec/No values, where larger Ec/No values result in larger portions allocated to each Cell. In this manner, Ec/No of different cells may be compared relative to one another.

In some implementations, user equipment 120 may determine a first radius 440 based on the third value of the first network cell and the display radius 420. For example, the third value can include the RSCP of the first network cell (Cell 1). In some implementations, determining a first radius 440 may include determining a first proportion based on the third value and a common value. In some implementations, first radius 440 may be based on the first proportion and display radius 420. For example, based on a relative proportion of RSCP of the first network cell 1, first radius 440 may be large if the proportion is large or may be small if the proportion is small.

In some implementations, user equipment 120 may allocate a third portion (illustrated in FIG. 4A as a portion delimited by line 438 and Cell 1) of the available cell pie-view display to be occupied based on the first radius and the first portion of the available cell pie-view display. In some implementations, the third portion may overlap the first portion. In some implementations, user equipment 120 may allocate the third portion to be contained within the first portion.

In some implementations, user equipment 120 may determine a second radius (not illustrated in FIG. 4A) based on the fourth value of the second network cell and display radius 420. In some implementations, determining the second radius may include determining a second proportion based on the fourth value and a common value. For example, the fourth value can include the RSCP of the second network cell (Cell 2). In some implementations, the second radius may be based on the second proportion and display radius 420. In some implementations, the common value used to determine the first proportion and the second proportion is the same value.

In some implementations, user equipment 120 may allocate a fourth portion (illustrated in FIG. 4A as a portion delimited by line 436 and Cell 1) of the available cell pie-view display to be occupied based on the second radius and the second portion of the available cell pie-view display. In some implementations, the fourth portion may overlap the second portion. In some implementations, user equipment 120 may allocate the fourth portion to be contained within the second portion.

In some implementations, the first, second, third and fourth portions of the available cell-pie view display may provide visualization of measurements of the first and second network cells relative to each other. In this manner, different attributes for different network cells may be visualized in a single display relative to one another. For example, both Ec/No values (indicated by the sizes of Cell 1 and Cell 2) and RSCP values (indicated by lines 438 and 436) may be visualized in a single display for Cells 1 and 2 relative to one another.

In some implementations, user equipment 120 may allocate an outer circle region 430 of the available cell pie-view display. For example, user equipment 120 may allocate outer circle region 430 of the available cell pie-view display that may represent various Cells 1 . . . 6.

In some implementations, user equipment 120 may allocate an inner circle region 402 of the available cell pie-view display for data representing user equipment 120 that is configured to track the first and second network cells. In some implementations, the data representing user equipment 120 may include a status of user equipment 120, a mode of user equipment, a channel mode of user equipment, a radio or procedure state of user equipment (such as during network registration or PDP context activation), and/or other data. In some implementations, allocating the inner circle region 402 may include allocating the inner circle region that does not overlap with the first and second portions of the available cell pie-view display. In other words, inner circle region 402 may not overlap with the other regions of the available cell pie-view display. In some implementations, allocating the inner circle region 402 may include allocating the inner circle region that does not overlap with the first, second, third, and fourth portions of the available cell pie-view display.

In some implementations, user equipment 120 may allocate a middle circle region 404 of the available cell pie-view display for data representing one or more carriers of the first network cell (Cell 1) and the second network cell (Cell 2). In some implementations, the middle circle region 404 may not overlap the inner circle region 402. In some implementations, the middle circle region 404 may include one or more portions 404A, 404B, 404C representing the one or more carriers of the first network cell and the second network cell. As illustrated, Cells 1, 2, and 3 are associated with a carrier represented by middle circle region 404B; Cell 4 is associated with a carrier represented by middle circle region 404A; and Cells 5-6 are associated with a carrier represented by middle circle region 404C).

In some implementations, user equipment 120 may allocate a first segment (illustrated in FIG. 4A as being defined in part by arc XY and lines radiating outward from inner circle region 402) of the available cell pie-view display that represents a first carrier. In some implementations, the first segment may comprise the first portion or the second portion of the available cell pie-view display depending on whether the first portion and the second portion represent Cells of the first carrier. In some implementations, user equipment 120 may allocate a second segment (illustrated in FIG. 4A as being defined in part by arc YZ and lines radiating outward from inner circle region 402) of the available cell pie-view display that represents a second carrier. In some implementations, the second segment may comprise the first portion or the second portion of the available cell pie-view display depending on whether the first portion and the second portion represent Cells of the first carrier.

In some implementations, user equipment 120 may allocate a color for at least one of the first portion, the second portion, the third portion, or the fourth portion based on their respective first, second, third, or fourth values.

In some implementations, user equipment 120 may allocate a color for at least one of: the first portion, the second portion, the third portion, or the fourth portion based on which of the respective first or second network cells is currently serving user equipment 120. For example, if the first network cell is currently serving user equipment 120, the first and third portions associated with the first network cell may be allocated a different color as compared to the second and fourth portions associated with the second network cell that is not currently serving user equipment 120.

In some implementations, user equipment 120 may allocate different colors to the inner circle region 402, the middle circle region 404 and the outer circle region 430. In some implementations, the various portions associated with each of these regions may each be allocated a different color.

In some implementations, user equipment 120 may generate the available cell pie-view display based on the first, second, third, and fourth portions. In some implementations, user equipment 120 may generate the available cell pie-view display based on inner circle region 402, the middle circle region 404, the outer circle region 430 and the portions associated with each of the regions. In some implementations, the generating may include generating the available cell pie-view display (i.e., the regions and/or portions) with the allocated colors.

In some implementations, at least a portion of the functions of user equipment 120 may be performed at server 110. In other words, server 110 may be configured to perform some or all of the functions performed by user equipment 120. In these implementations, for example, server 110 may be communicably coupled to user equipment 120 such that some or all information (such as measurements, allocations, etc) required to complete the functions are communicated between the two. In these implementations, some or all of the described functions of user equipment 120 is performed by either or both server 110 and user equipment 120.

In some implementations, user equipment 120 may comprise a processor (not otherwise illustrated in FIG. 1) that includes one or more processors configured to perform various functions of user equipment 120. In some implementations, user equipment 120 may comprise a memory (not otherwise illustrated in FIG. 1) that includes one or more tangible (i.e., non-transitory) computer readable media. The memory of user equipment 120 may include one or more instructions that when executed by the processor of user equipment 120 configure s the processor to perform the functions of user equipment 120. User equipment 120 may include a user interface (not otherwise illustrated in FIG. 1) that may enable users to perform various operations that may facilitate interaction with server 110 including, for example, transmitting/uploading measurements, providing requests for serving cell pie-view displays and/or available cell pie-view displays, receiving the displays, and/or performing other operations.

According to various implementations of the invention, server 110 may include processor 112, memory 114, and/or other components that facilitate the functions of server 110 described herein. In some implementations, processor 112 includes one or more processors configured to perform various functions of server 110. In some implementations, memory 114 includes one or more tangible (i.e., non-transitory) computer readable media. Memory 114 may include one or more instructions that when executed by processor 112 configure processor 112 to perform the functions of server 110. In some implementations, memory 114 may include one or more instructions stored on tangible computer readable media that when executed at a remote device, such as user equipment 120, cause the remote device to measure values of various attributes that indicate performance of one or more network cells, allocate various portions of a cell pie-view display based on the measured values, generate the cell pie-view display, and/or perform other functions, as described herein

FIGS. 2A and 2B are diagrams depicting exemplary presentation modes/views for visualizing performance of a serving cell, according to various implementations of the invention.

FIG. 2A depicts an exemplary serving cell pie-view display that is generated when user equipment 120 is using WCDMA technology (in other words, the serving cell is associated with/uses WCDMA technology). Inner circle portion 202 of the serving cell pie-view display may be associated the first attribute (Ec/N0) of the serving cell. In some implementations, inner circle portion 202 may be substantially circular having a total angle of 360 degrees. Inner radius 204 may represent the first attribute of the serving cell. In some implementations, inner radius 204 of the inner circle portion 202 may be based on the first value associated with the first attribute.

First portion 206 of the serving cell pie-view display may be associated with the second attribute (RSCP) of the serving cell. First angle 208 may represent the second attribute of the serving cell. In some implementations, first angle 208 may be based on the second value associated with the second attribute. In some implementations, first portion 206 may be based on the first angle 208 and first radius 210.

Second portion 212 of the serving cell pie-view display may be associated with the third attribute (transmit power) used by user equipment 120. Second angle 214 may represent the third attribute of the serving cell. In some implementations, second angle 214 may be based on the third value associated with the third attribute. In some implementations, second portion 212 may be based on the second angle 214 and second radius 216.

As can be seen in FIG. 2A, segments/areas of inner circle portion 202, first portion 206 and second portion 212 may overlap with each other.

FIG. 2B depicts an exemplary serving cell pie-view display that is generated when user equipment 120 is using GSM technology Inner circle portion 230 of the serving cell pie-view display may be associated the first attribute (C1) of the serving cell. In some implementations, inner circle portion 230 may be substantially circular having a total angle of 360 degrees. Inner radius 232 may represent the first attribute of the serving cell. In some implementations, inner radius 232 of the inner circle portion 230 may be based on the first value associated with the first attribute.

First portion 234 of the serving cell pie-view display may be associated with the second attribute (RxLev) of the serving cell. First angle 236 may represent the second attribute of the serving cell. In some implementations, first angle 236 may be based on the second value associated with the second attribute. In some implementations, first portion 234 may be based on the first angle 236 and first radius 238.

Second portion 240 of the serving cell pie-view display may be associated with the third attribute (transmit power) used by user equipment 120. Second angle 242 may represent the third attribute of the serving cell. In some implementations, second angle 242 may be based on the third value associated with the third attribute. In some implementations, second portion 240 may be based on the second angle 242 and second radius 244.

FIG. 3 is a diagram illustrating a screen shot of an exemplary presentation mode/view for visualizing performance of a serving cell, according to various implementations of the invention. FIG. 3 depicts a screenshot 300 of a serving cell pie-view display that is generated when user equipment 120 is using WCDMA technology (in other words, the serving cell is associated with/uses WCDMA technology). The serving cell pie-view display may be generated and displayed at user equipment 120

Inner circle region 202 of the serving cell pie-view display may be colored green to indicate a good Ec/N0 value associated with the serving cell. First portion 206 may be colored red to indicate a poor RSCP value associated with the serving cell. Second portion 212 may be colored red to indicate a poor transmit power value associated with user equipment 120.

As can be seen in FIG. 3, segments/areas of inner circle portion 202, first portion 206 and/or second portion 212 may overlap with each other. In some implementations, the overlapping segments/areas and/or other segments/areas (for example, 310, 312, 314, 316) of the inner circle portion 202, first portion 206 and/or second portion 212 may be semi-transparent and may be allocated a color in the spectrum between red and green to represent how good each metric is (e.g., a “poor” value may be indicated as red, an average value may be indicated as a color in between red and green, and “good” value may be indicated as green).

FIGS. 4A and 4B are diagrams depicting exemplary presentation modes/views for visualizing performance of network cells relative to one another, according to various implementations of the invention.

FIG. 4A depicts an exemplary available cell pie-view display 400 that is generated when user equipment 120 is using WCDMA technology (in other words, the network cell is associated with/uses WCDMA technology). In some implementations, available cell pie-view display 400 may include a substantially circle display having a total angle of 360 degrees and display radius 420.

Inner circle region 402 may indicate data representing user equipment 120 that is configured to track one or more network cells (for example, WCDMA cells). Inner circle region 402 may indicate whether user equipment is in idle mode or in dedicated mode. For example, inner circle region 402 may include the letter “S” indicating that user equipment 120 is in idle mode. Other data representing user equipment 120 may be depicted in inner circle region without departing from the scope of the invention.

Middle circle region 404 may indicate data representing one or more carriers associated with the one or more network cells (for example, WCDMA carrier frequencies). Middle circle region 404 may include one or more portions for representing data associated with the one or more carriers. For example, middle region 404 of FIG. 4A includes three portions 404A, 404B, 404C for representing data associated with three carriers (Carrier 1, Carrier 2, Carrier 3, respectively).

In some implementations, available cell pie-view display 400 may comprise one or more segments that represent the one or more carriers. For example, a portion spanned by arc XY may represent a first segment, a portion spanned by arc YZ may represent a second segment, and a portion spanned by arc ZX may represent a third segment. The first segment may represent a first carrier, the second segment may represent a second carrier and the third segment may represent a third carrier.

In some implementations, an angle 406 associated with portion 404C of middle circle region 404 may represent a carrier attribute associated with carrier 3, for example. In some implementations, angle 406 may represent the UTRA Carrier RSSI of carrier 3. UTRA Carrier RSSI may represent the received wide band power, i.e., the received power of a 5 MHz WCDMA UTRA carrier, wherein the UTRA carrier may contain multiple WCDMA cells. In some implementations, angle 406 may be based on a value associated with the carrier attribute (that is associated with carrier 3). In some implementations, angle 406 may represent the UTRA carrier RSSI for carrier 3 compared to other carrier frequencies. In some implementations, angles associated with portions 404A and 404B (not otherwise illustrated in FIG. 4A) of middle circle region 404 may similarly represent carrier attributes associated with carriers 1 and 2, respectively (for example, UTRA Carrier RSSI of carriers 1 and 2, respectively). The angle associated with portion 404A may be based on a value associated with the carrier attribute that is associated with carrier 1. The angle associated with portion 404B may be based on a value associated with the carrier attribute that is associated with carrier 2. As such, the angles associated with the portions 404A, 404B, and 404C of middle circle region 404 provide a visual comparison of the UTRA Carrier RSSI values of the associated carriers. Other carrier attributes (for example, UARFCN, i.e., UMTS Absolute Radio Frequency Channel Number, and/or other carrier attributes) may be depicted in middle circle region without departing from the scope of the invention.

In some implementations, outer circle region 430 may indicate data representing one or more network cells (for example WCDMA cells) being tracked by user equipment 120. In some implementations, the data may include measurements of at least a first attribute and a second attribute that indicate performance of the one or more network cells. In some implementations, the first attribute may be Ec/N0 associated with the one or more network cells. In some implementations, the second attribute may be RSCP associated with the one or more network cells. Data regarding other attributes associated with the network cells (for example, scrambling code, and/or other attributes) may be represented without departing from the scope of the invention.

Portions of outer circle region 430 represent cell 1, cell 2, cell 3, cell 4, cell 5, and cell 6. Cell 1, cell 2, and cell 3 may be associated with carrier 2. Cell 4 may be associated with carrier 1. Cell 5 and cell 6 may be associated with carrier 3. In some implementations, the first segment (i.e., a portion spanned by arc XY) may include cell 1, cell 2, and cell 3. In some implementations, the second segment (i.e., a portion spanned by arc YZ) may include cell 4. In some implementations, the third segment (i.e., a portion spanned by arc ZX) may include cell 5 and cell 6.

In some implementations, a first portion of the available cell pie-view display 400 may be associated with a first network cell (for example, cell 1). In some implementations, the outer circle region 430 may include the first portion. In some implementations, the first portion may be allocated based on a first value (i.e., a first value associated with the first attribute Ec/N0) of the first network cell. In some implementations, the first portion may be based on the first value of cell 1 and the total angle (360 degrees) associated with the available cell pie-view display 400. For example, angle 432 may represent the first value of cell 1. In these implementations, angle 432 may be based on the first value of cell 1 and the total angle. In some implementations, angle 432 may be based on the first value of cell 1 in relation to the sum of corresponding first values of all other cells (2.6), which in turn yields angle 432 in relation to the total angle. In other words, angle 432 may be a proportion of the total angle based on a proportion of the first value of cell 1 with respect to the first values of one or more other cells. In some implementations, angle 432 may represent Ec/N0 of cell 1 compared to other cells using the same carrier frequency.

In some implementations, a second portion of the available cell pie-view display 400 may be associated with a second network cell (for example, cell 2). In some implementations, the outer circle region 430 may include the second portion. In some implementations, the second portion may be allocated based on a second value (i.e., a second value associated with the first attribute Ec/N0) of the second network cell. In some implementations, the second portion may be based on the second value of cell 1 and the total angle (360 degrees) associated with the available cell pie-view display 400.

In a similar manner, various additional portions of the available cell pie-view display 400 may be associated with cell 3, cell 4, cell 5, and cell 6. In these implementations, outer circle region 430 may include these additional portions. Each of these portions may be allocated based on the respective Ec/N0 value associated with the respective cell. For example, a portion associated with cell 3 may be based on the Ec/No value for cell 3, and so on. In some implementations, each of these portions may be based on respective Ec/N0 value of the respective cell and the total angle (360 degrees) associated with the available cell pie-view display 400. In some implementations, angles associated with the corresponding values of cells 2-6 may be determined in a manner similar to angle 432 associated with cell 1.

In some implementations, a third portion of the available cell pie-view display 400 may be associated with a first network cell (for example, cell 1). In some implementations, the outer circle region 430 may include the third portion. In some implementations, the first portion of the first network cell may include the third portion. In some implementations, the third portion may be allocated based on a first radius 440 and the first portion. In some implementations, first radius 440 may be based on a third value (i.e., a third value associated with the second attribute RSCP) of the first network cell. In some implementations, first radius 440 may be based on the third value and display radius 420. For example, a position of line 438 may represent the third value of cell 1. In these implementations, the position of line 438 may define the third portion which may be based on first radius 440 and the first portion. For example, the portion below line 438 may represent the third portion which may be contained within the first portion associated with the first network cell.

In some implementations, a fourth portion of the available cell pie-view display 400 may be associated with a second network cell (for example, cell 2). In some implementations, the outer circle region 430 may include the fourth portion. In some implementations, the second portion of the first network cell may include the fourth portion. In some implementations, the fourth portion may be allocated based on a second radius (not otherwise illustrated in FIG. 4A) and the second portion. In some implementations, the second radius may be based on a fourth value (i.e., a fourth value associated with the second attribute RSCP) of the second network cell. In some implementations, the second radius may be based on the fourth value and display radius 420. For example, a position of line 436 may represent the fourth value of cell 2. In these implementations, the position of line 436 may define the fourth portion which may be based on the second radius and the second portion. For example, the portion below line 436 may represent the fourth portion which may be contained within the second portion associated with the second network cell.

In a similar manner, various additional portions of the available cell pie-view display 400 and/or outer circle region 430 representing the RSCP values associated with cell 3, cell 4, cell 5, and cell 6 (line 434 for cell 6, for example) may be depicted, without departing from the scope of the invention.

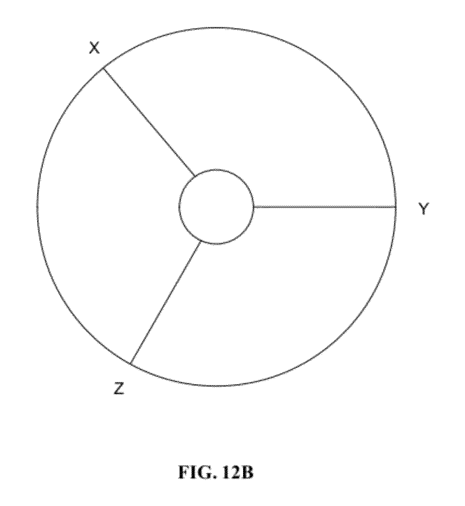

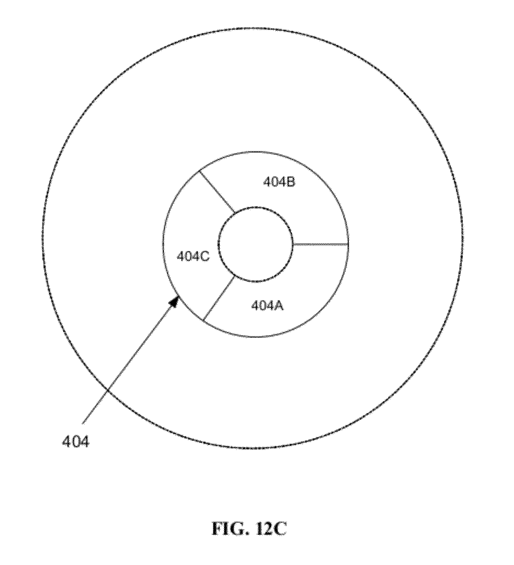

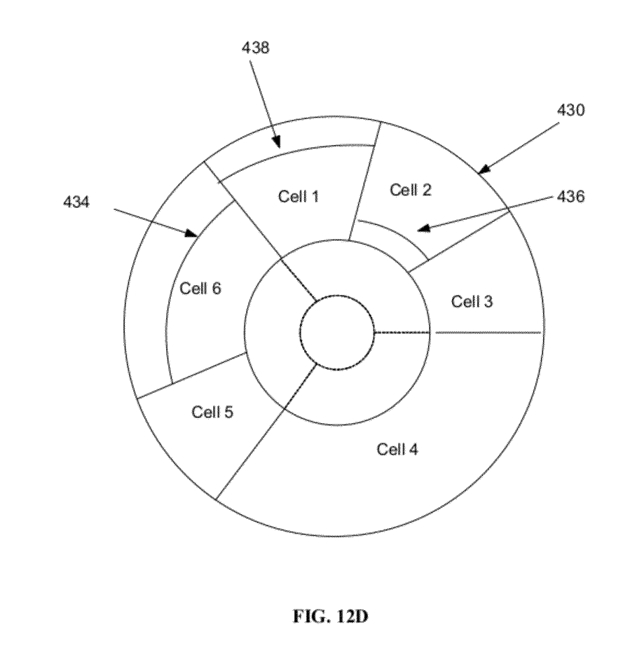

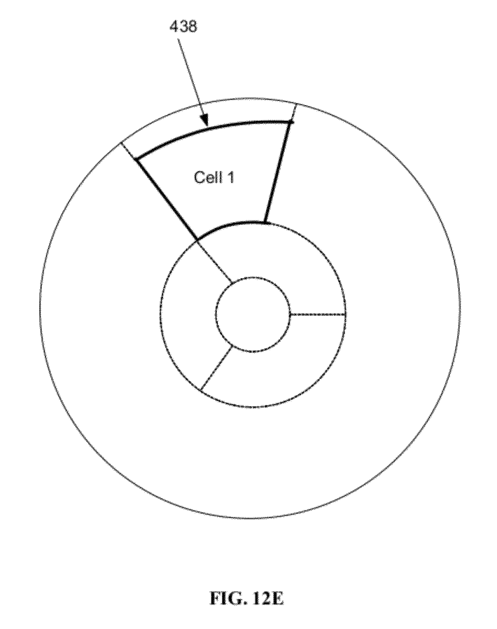

FIGS. 12A-12E are diagrams depicting exemplary regions and/or portions of FIG. 4A, according to various implementations of the invention. For example, FIG. 12A depicts inner circle region 402. FIG. 12B depicts segments that represent the one or more carriers. FIG. 12C depicts middle circle region 404. FIG. 12D depicts outer circle region 430. FIG. 12E depicts a third portion associated with cell 1. In other words, when superimposed together, FIGS. 12A-12E, illustrate FIG. 4A.

FIG. 4B depicts an exemplary available cell pie-view display 450 that is generated when user equipment 120 is using WCDMA technology (in other words, the network cell is associated with/uses WCDMA technology). In some implementations, similar available cell pie-view displays may be generated when user equipment uses different types of radio access technologies (for GSM and/or other types of radio access technologies) as would be appreciated based on the disclosure herein. The measurements, values, parameters depicted in these displays are illustrative only and may vary based on the type of radio access technology being visualized.

The available cell pie-view display 450 may be generated based on the following exemplary measurements, values, and/or attributes. The measurements, values, and/or attributes may be based on WCDMA technology. For example, user equipment 120 may measure an UTRA Carrier RSSI of −69 dBm. A UTRA carrier may contain multiple WCDMA cells (for example, cell 1, cell 2, and cell 3). In this example, only one UTRA carrier may be used.

For each cell, user equipment 120 may measure corresponding RSCP values. For example, RSCP for cell 1 may be −72 dBm, RSCP for cell 2 may be −75 dBm, and RSCP for cell 3 may be −78 dBm. Based on the RSCP values and the UTRA Carrier RSSI value, the corresponding Ec/N0 values for each cell may be determined.

In some implementations, for a WCDMA cell with a cell specific RSCP and Ec/N0 on a WCDMA carrier with a specific UTRA Carrier RSSI, Ec/N0 may be determined based on the following equation:

Ec/N0=RSCP/UTRA Carrier RSSI (1)

In case the RSCP and UTRA Carrier RSSI values are in dBm, the equation may correspond to Ec/N0=RSCP−UTRA Carrier RSSI

As such, the Ec/N0 values for cell 1, cell 2 and cell 3 may be determined as follows:

Ec/N0 for cell 1=−72−(−69)=−3 dB

Ec/N0 for cell 2=−75−(−69)=−6 dB

Ec/N0 for cell 3=−78−(−69)=−9 dB

Since the Ec/N0 values are in dB, these values may be converted to original values (i.e., power ratio: RSCP/UTRA Carrier RSSI) using the ratio equation 10̂((Ec/N0)/10).

Thus, the power ratios for cell 1, cell 2 and cell 3 may be determined as follows:

Power ratio for cell 1=10̂(−3/10)=0.501187

Power ratio for cell 2=10̂(−6/10)=0.251189

Power ratio for cell 3=10̂(−9/10)=0.125893

The power ratio of 0.501187 may indicate that approximately 50.1% of the total UTRA Carrier power measured by user equipment 120 belongs to cell 1. The power ratio of 0.251189 may indicate that approximately 25.1% of the total UTRA Carrier power measured by user equipment 120 belongs to cell 2. The power ratio of 0.125893 may indicate that approximately 12.6% of the total UTRA Carrier power measured by user equipment 120 belongs to cell 3.

A portion of available cell pie-view display 450 to be allocated to cell 1 may be determined based on the following equation:

Power ratio of cell 1*360(which represents the total angle of 360 degrees)

Sum of power ratios for

cell 1,cell 2 and cell 3 (2)

A portion of available cell pie-view display 450 to be allocated to cell 2 may be determined based on the following equation:

Power ratio of cell 2*360

Sum of power ratios for

cell 1,cell 2 and cell 3 (3)

A portion of available cell pie-view display 450 to be allocated to cell 3 may be determined based on the following equation:

Power ratio of cell 3*360

Sum of power ratios for

cell 1,cell 2 and cell 3 (4)

Thus, the allocated portion for cell 1 may be determined as follows:

0.501187/(0.501187+0.251189+0.125893)*360=205 degrees.

Thus, the allocated portion for cell 2 may be determined as follows:

0.251189/(0.501187+0.251189+0.125893)*360=103 degrees.

Thus, the allocated portion for cell 3 may be determined as follows:

0.125893/(0.501187+0.251189+0.125893)*360=52 degrees.

In some implementations, the allocated portions for cell 1, cell 2, and cell 3 may be included in outer circle region 430 of available cell pie-view display 450. In some implementations, the allocated portions for cell 1, cell 2, and cell 3 in the outer circle region 430 may be depicted in shades of green. Other colors may be used without departing from the scope of the invention.

In some implementations, RSCP percentage values for each cell may be determined based on the following equation:

(RSCP for cell−RSCP_{MIN})/(RSCP_{MAX}−RSCP_{MIN}) (5)

Thus, the RSCP percentage value for cell 1 may be determined as follows:

(−72−(−116))/(−40−(−116))=0.5789

Thus, the RSCP percentage value for cell 2 may be determined as follows:

(−75−(−116))/(−40−(−116))=0.5395

Thus, the RSCP percentage value for cell 3 may be determined as follows:

(−78−(−116))/(−40−(−116))=0.5000

In some implementations, the RSCP/RSCP percentage values may determine additional portions of available cell pie-view display 450 to be allocated to cell 1, cell 2, and cell 3. These additional portions for cell 1, cell 2, and cell 3 may be included in outer circle region 430 of available cell pie-view display 450. In some implementations, the additional portions for cell 1, cell 2, and cell 3 in the outer circle region 430 may be depicted in shades of pink. Other colors may be used without departing from the scope of the invention. In some implementations, the additional portions for cell 1, cell 2 and cell 3 may be contained within the allocated portions for cell 1, cell 2, and cell 3 respectively. In some implementations, the additional portions for cell 1, cell 2 and cell 3 may overlap the allocated portions for cell 1, cell 2, and cell 3 respectively.

In some implementations, the RSCP percentage value for cell 1 may indicate that the allocated portion for cell 1 may be filled (i.e., filled by a shade of pink) to 57.9%. The RSCP percentage value for cell 2 may indicate that the allocated portion for cell 2 may be filled (i.e., filled by a shade of pink) to 54.0%. The RSCP percentage value for cell 3 may indicate that the allocated portion for cell 3 may be filled (i.e., filled by a shade of pink) to 50.0%.

In some implementations, a radius associated with an additional portion may be determined based on the RSCP/RSCP percentage value associated with each cell. The radius may be determined based on following equation:

Display radius*RSCP percentage value for cell (6)

Thus, a radius 462 for the additional portion of cell 1 may be determined by: display radius 420*RSCP percentage value for cell 1. Radius 464 for the additional portion of cell 2 may be determined by: display radius 420*RSCP percentage value for cell 2. Radius 466 for the additional portion of cell 2 may be determined by: display radius 420*RSCP percentage value for cell 3.

In some implementations, a position of line 452 may represent the RSCP/RSCP percentage value for cell 1. In some implementations, the position of line 452 may be based on radius 462. In some implementations, a position of line 454 may represent the RSCP/RSCP percentage value for cell 2. In some implementations, the position of line 454 may be based on radius 464. In some implementations, a position of line 456 may represent the RSCP/RSCP percentage value for cell 3. In some implementations, the position of line 456 may be based on radius 466.

In some implementations, available cell-pie view display 450 may include inner circle region 402. Inner circle region 402 may indicate data representing user equipment 120 that is configured to track cell 1, cell 2, and cell 3. In some implementations, available cell-pie view display 450 may include middle circle region 404. Middle circle region 404 may indicate data representing one or more carriers associated with cell 1, cell 2, and cell 3. In this example, since only one carrier is used, middle circle region 404 may indicate data representing the single carrier. In some implementations, inner circle region 402 may allocated a color that is different from the colors used in the outer circle region 430 and middle circle region 404.

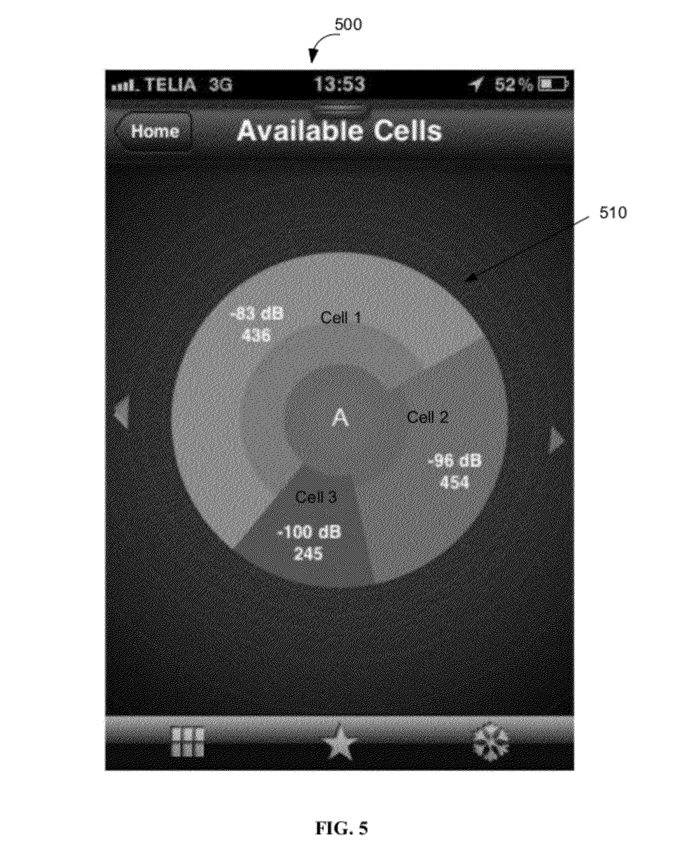

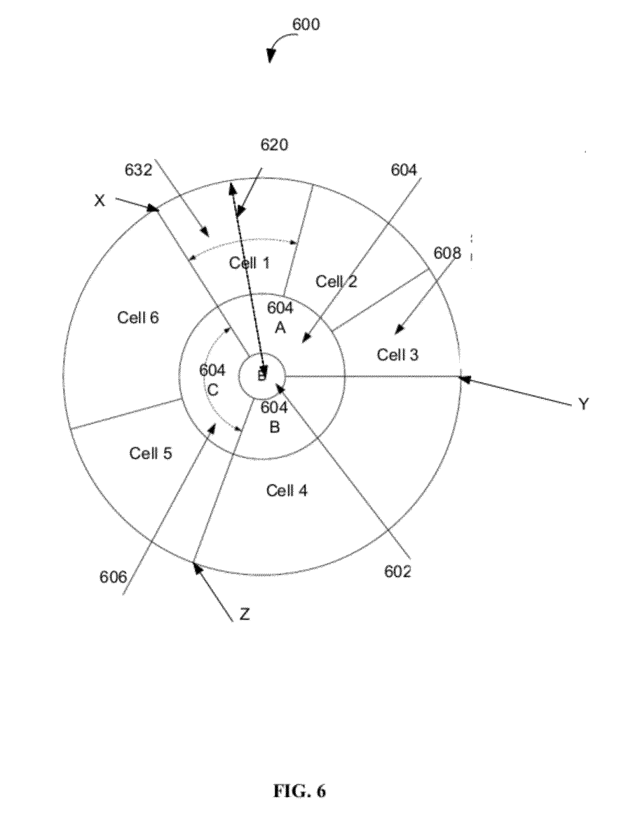

FIG. 5 is a diagram illustrating a screen shot of an exemplary presentation mode/view for visualizing performance network cells relative to one another, according to various implementations of the invention. FIG. 5 depicts a screenshot 500 of an available cell pie-view display 510 that is generated when user equipment 120 is using WCDMA technology. Available cell pie-view display 510 may be generated and displayed at user equipment 120. Available cell pie-view display 510 depicted in FIG. 5 is generated in a similar manner as the available cell pie-view display 450 of FIG. 4B. The allocated and additional portions of available cell pie-view display 510 are depicted in different colors as compared to those of cell pie-view display 450. As such, various different color combinations may be used to depict various regions and/or portions of available cell pie-view display 450/510 without departing from the scope of the invention. In some implementations, the RSCP values associated with cell 1, cell 2, and cell 3 (for example, −83 dB, −96 dB, and −100 dB, respectively) may be depicted in available cell pie-view display 510. In some implementations, scrambling code information associated with cell 1, cell 2, and cell 3 (for example, 436, 454, and 245, respectively) may be depicted in available cell pie-view display 510.

FIG. 6 is a diagram depicting exemplary presentation modes/views for visualizing performance of network cells relative to one another, according to various implementations of the invention. FIG. 6 depicts an exemplary available cell pie-view display 600 that is generated when user equipment 120 is using GSM technology (in other words, the network cell is associated with/uses GSM technology).

In some implementations, available cell pie-view display 600 may include a substantially circle display having a total angle of 360 degrees and display radius 620.

Inner circle region 602 may indicate data representing user equipment 120 that is configured to track one or more network cells (for example, GSM cells). Inner circle region 602 may indicate a channel mode used by user equipment 120. For example, inner circle region 602 may include the letter “B” indicating that the channel mode is BCCH (Broadcast Control Channel). Inner circle region 602 may include the letter “S” indicating that the channel mode is SDCCH (Stand-alone Dedicated Control Channel). Inner circle region 602 may include the letter “T” indicating that the channel mode is TCH (Traffic Channel). Inner circle region 602 may include the letter “P” indicating that the channel mode is PBCCH (Packet Broadcast Control Channel). Inner circle region 602 may include the letter “D” indicating that the channel mode is PDTCH (Packet Data Traffic Channel). Other data representing user equipment 120 may be depicted in inner circle region without departing from the scope of the invention.

Middle circle region 604 may indicate data representing one or more frequency bands associated with the one or more network cells (for example, GSM frequency bands). Middle circle region 604 may include one or more portions for representing data associated with the one or more frequency bands. For example, middle region 604 of FIG. 4A includes three portions 604A, 604B, 604C for representing data associated with three frequency bands (Band 1, Band 2, Band 3, respectively).

In some implementations, available cell pie-view display 600 may comprise one or more segments that represent the one or more frequency bands. For example, a portion spanned by arc XY may represent a first segment, a portion spanned by arc YZ may represent a second segment, and a portion spanned by arc ZX may represent a third segment. The first segment may represent a first frequency band, the second segment may represent a second frequency band and the third segment may represent a third frequency.

In some implementations, an angle 606 associated with portion 604C of middle circle region 604 may be determined based on the received signal levels (RxLev's) of the cells (cell 5 and cell 6) using band 3, for example. In some implementations, angles associated with portions 604A and 604B (not otherwise illustrated in FIG. 4A) of middle circle region 604 may be similarly determined based on the RxLev's of the cells using the respective bands 1 and 2. For example, the angle associated with portion 604A may be based on RxLev's of cells 1, 2, and 3 using band 1. The angle associated with portion 604B may be based on RxLev of cell 4 using band 2. As such, the angles associated with the portions 604A, 604B, and 604C of middle circle region 604 provide a visual comparison of the RxLev values associated with the bands. Other attributes (for example, band name, and/or other attributes) may be depicted in middle circle region without departing from the scope of the invention.

In some implementations, outer circle region 608 may indicate data representing one or more network cells (for example GSM cells) being tracked by user equipment 120. In some implementations, the data may include measurements of at least a first attribute that indicates performance of the one or more network cells. In some implementations, the first attribute may be RxLev associated with the one or more network cells. Data regarding other attributes associated with the network cells (for example, ARFCN—Absolute Radio Frequency Channel Number, and/or other attributes) may be represented without departing from the scope of the invention.

Portions of outer circle region 608 represent cell 1, cell 2, cell 3, cell 4, cell 5, and cell 6. Cell 1, cell 2, and cell 3 may be associated with band 1. Cell 4 may be associated with band 2. Cell 5 and cell 6 may be associated with band 3. In some implementations, the first segment (i.e., a portion spanned by arc XY) may include cell 1, cell 2, and cell 3. In some implementations, the second segment (i.e., a portion spanned by arc YZ) may include cell 4. In some implementations, the third segment (i.e., a portion spanned by arc ZX) may include cell 5 and cell 6.

In some implementations, a first portion of the available cell pie-view display 600 may be associated with a first network cell (for example, cell 1). In some implementations, the outer circle region 608 may include the first portion. In some implementations, the first portion may be allocated based on a first value (i.e., a first value associated with the first attribute RxLev) of the first network cell. In some implementations, the first portion may be based on the first value of cell 1 and the total angle (360 degrees) associated with the available cell pie-view display 600. For example, angle 632 may represent the first value of cell 1. In these implementations, angle 632 may be based on the first value of cell 1 and the total angle. In some implementations, angle 632 may be based on the first value of cell 1 in relation to the sum of corresponding first values of all other cells (2 . . . 6), which in turn yields angle 632 in relation to the total angle. In some implementations, angle 632 may represent RxLev of cell 1 compared to other cells.

In some implementations, a second portion of the available cell pie-view display 600 may be associated with a second network cell (for example, cell 2). In some implementations, the outer circle region 608 may include the second portion. In some implementations, the second portion may be allocated based on a second value (i.e., a second value associated with the first attribute RxLev) of the second network cell. In some implementations, the second portion may be based on the second value of cell 1 and the total angle (360 degrees) associated with the available cell pie-view display 600.

In a similar manner, various additional portions of the available cell pie-view display 600 may be associated with cell 3, cell 4, cell 5, and cell 6. In these implementations, outer circle region 608 may include these additional portions. Each of these portions may be allocated based on the respective RxLev value associated with the respective cell. For example, a portion associated with cell 3 may be based on the RxLev value for cell 3, and so on. In some implementations, each of these portions may be based on respective RxLev value of the respective cell and the total angle (360 degrees) associated with the available cell pie-view display 600. In some implementations, angles associated with the corresponding values of cells 2-6 may be determined in a manner similar to angle 632 associated with cell 1.

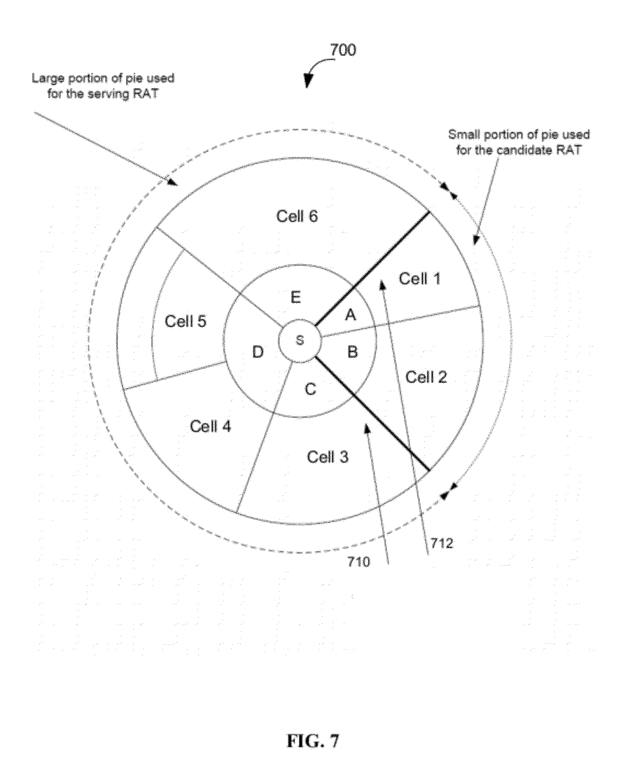

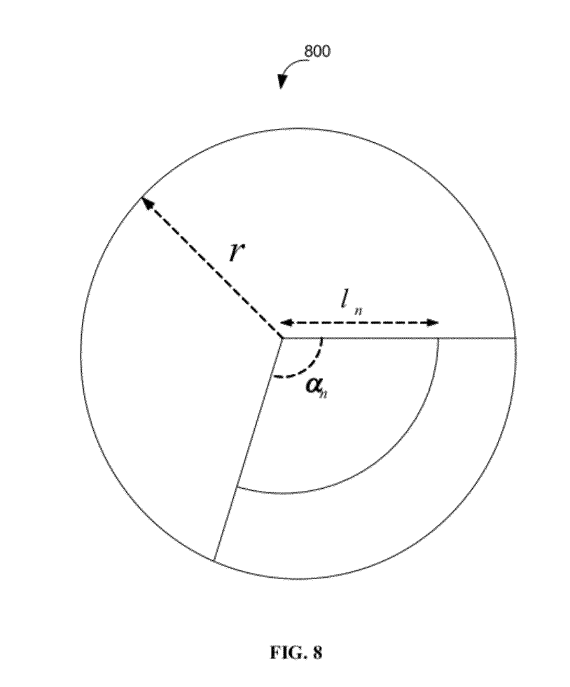

FIG. 7 is a diagram illustrating an exemplary presentation mode/view 700 for visualizing network cells of different radio access technologies (RATs) relative to one another during a compressed mode for potential handover, according to various implementations of the invention. Presentation mode/view 700 illustrates a serving RAT (i.e., a RAT being used by a serving cell) and a candidate RAT (i.e., a RAT being used by a cell to which a handover may take place). In some implementations, the serving RAT and the candidate RAT may be allocated different proportions of the available cell pie-view display. For example, as illustrated, the serving RAT is allocated a larger proportion of an available cell pie-view display while the candidate RAT is allocated a smaller proportion of the available cell pie-view display. As would be appreciated, the serving RAT can be allocated a smaller proportion of the available cell pie-view display than the candidate RAT. In other implementations not illustrated, the serving RAT and the candidate RAT may be allocated similar proportions.

According to various implementations, presentation mode/view 700 may include the features (such as visualization of values of attributes) of the various implementations illustrated in FIGS. 4-6. For example, as illustrated, the center of presentation mode/view 700 includes an inner circle portion that represents a user equipment in a particular mode denoted by “S.” As further illustrated, the candidate RAT includes two carriers A and B. Carrier A includes Cell 1 and Carrier B includes Cell 2. The serving RAT includes three Carriers C, D, and E. Carrier C includes Cell 3; carrier D includes Cells 4 and 5; and Carrier E includes Cell 6. As would be appreciated, the display may represent any number of carriers each having any number of Cells. In some implementations, bold lines 710, 712, different colors, and/or other visual cues may be used to indicate that two different type of radio access technologies are depicted.

FIG. 8 is a diagram illustrating a generic presentation mechanism 800, according to various implementations of the invention. The various displays illustrated in FIGS. 2-7 use combinations of generic presentation mechanism 800 to visualize values of different attributes relative to one another. In other words, by using the building block provided by generic presentation mechanism 800, various implementations of displays for visualizing attributes relative to one another may be achieved. As illustrated, generic presentation mechanism 800 shows an entity Aₙ (such as a network cell) having allocated a proportionate angle (αₙ) and inner arch delimiter with radius (lₙ). Each of αₙ and lₙ may be based on different values for different attributes. Based on the example below, generic presentation mechanism 800 for entity Aₙ may be combined with other generic presentation mechanisms 800 of other entities Aₙ in order to generate the displays illustrated in FIGS. 2-7.

In some implementations, for example, entities Aₙ have individual attributes Qₙ and Rₙ, while sharing attribute P. Qₙ and Rₙ is compared to P according to the following equations. For display purposes a circle with radius (r) is used to present the relationships between the given parameters, as generally described by the following equations.

1≦n<∞ (8),

where any number n of entities may be used to generate proportion with respect to one another;

$$\begin{matrix}{Q}_{n}^{Ratio} = \frac{{Q}_{n}}{P} , & ( 9 ) \\ {α}_{n} = \frac{{Q}_{n}^{Ratio}}{{\sum }_{i = 1}^{n} {Q}_{i}^{Ratio}} * 360 , & ( 10 ) \\ {R}_{n}^{Ratio} = \frac{{R}_{n} - {Q}_{min}}{{Q}_{max} - {Q}_{min}} , & ( 11 )\end{matrix}$$

Where Qₘᵢₙ and Qₘₐₓ are the lower and upper limits of these values;

lₙ=r*Rₙ^{Ratio} (12)

Visualization according to generic presentation mechanism 800 may be useful when comparing entities that are related through a common, shared attribute. Generic presentation mechanism 800 may be especially useful when the attribute is expressed in a unit that is not always easily comprehensible to human interpretation, such as decibel.

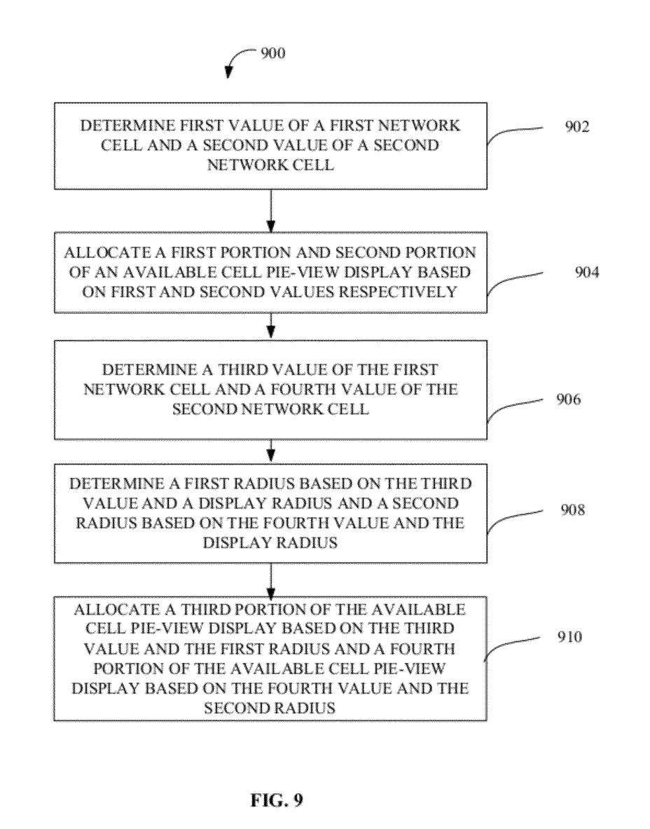

FIG. 9 is a flow diagram illustrating an example process 900 of visualizing performance of one or more network cells relative to one another, according to various implementations of the invention. The various processing operations and/or data flows depicted in FIG. 2 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations of the invention, in an operation 902, process 900 may determine a first value of a first network cell and a second value of a second network cell, wherein the first and second values may be based on measurements of a first attribute that indicates performance of the first and second network cells.

In some implementations, in an operation 904, process 900 may allocate a first portion of an available cell pie-view display to be occupied based on the first value and a second portion of the available cell pie-view display to be occupied based on the second value. In some implementations, the available cell pie-view display may include a substantially circular display having a total angle of 360 degrees and a display radius. In some implementations, the first portion may be based on the first value and the total angle. In some implementations, the second portion may be based on the second value and the total angle.

In some implementations, in an operation 906, process 900 may determine a third value of the first network cell and a fourth value of the second network cell, wherein the third and fourth values may be based on measurements of a second attribute that indicates performance of the first and second network cells. In some implementations, the second attribute may be different than the first attribute.

In some implementations, in an operation 908, process 900 may determine a first radius based on the third value and the display radius and a second radius based on the fourth value and the display radius.

In some implementations, in an operation 910, process 900 may allocate a third portion of the available cell pie-view display to be occupied based on the first radius and the first portion and a fourth portion of the available cell pie-view display to be occupied based on the second radius and the second portion. In some implementations, the third portion may overlap the first portion and the fourth portion may overlap the second portion. In some implementations, the first, second, third and fourth portions provide visualization of measurements of the first and second network cells relative to each other.

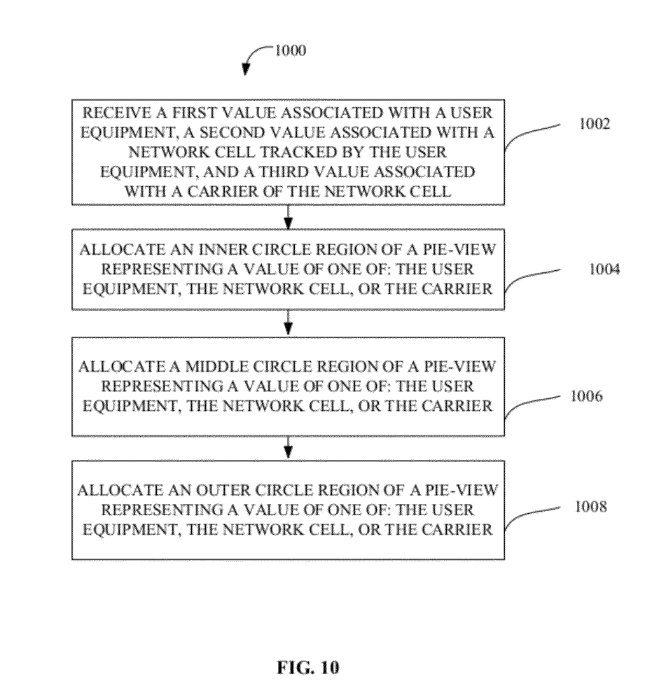

FIG. 10 is a flow diagram illustrating an example process 1000 of visualizing different components of a communications network, the components comprising user equipment, network cells, and carriers of the network cells, according to various implementations of the invention. In some implementations of the invention, in an operation 1002, process 1000 may receive a first value associated with a user equipment, a second value associated with a network cell being tracked by the user equipment, and a third value associated with a carrier of the network cell.

In some implementations, in an operation 1004, process 1000 may allocate an inner circle region of a pie-view representing a value for one of: the user equipment, the network cell, or the carrier. In some implementations, the pie-view display may include a substantially circular display having a total angle of 360 degrees.

In some implementations, in an operation 1006, process 1000 may allocate a middle circle region of the pie-view representing a value for one of: the user equipment, the network cell, or the carrier not displayed in the inner circle.

In some implementations, in an operation 1008, process 1000 may allocate an outer circle region of the pie-view representing a value for one of: the user equipment, the network cell, or the carrier not displayed in the inner circle region and the middle circle region. In some implementations, the inner circle region, the middle circle region, and the outer circle region may be configured to collectively represent the first, second, and third values.

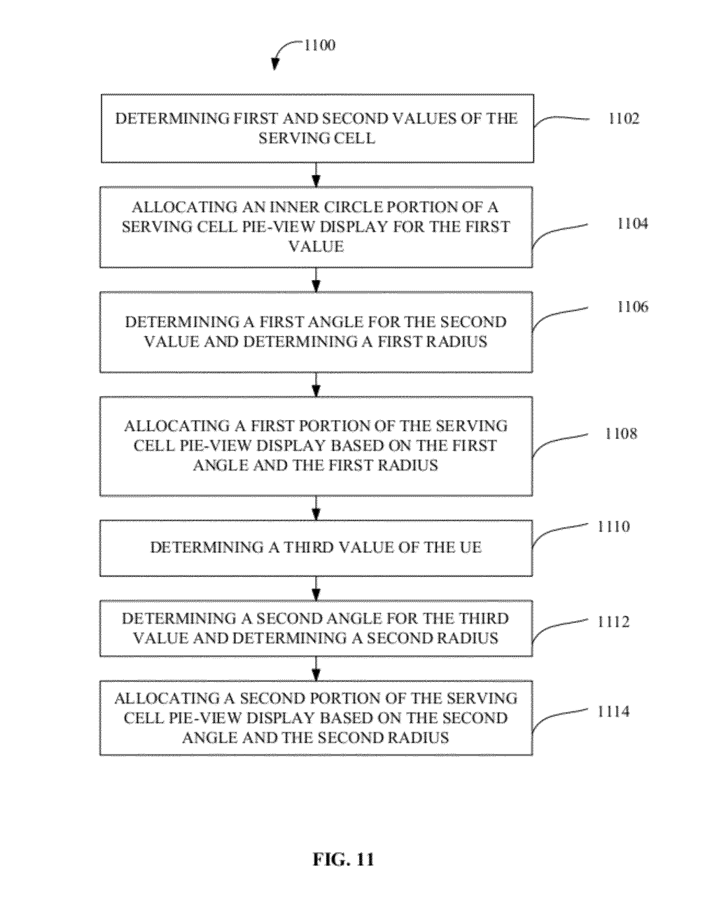

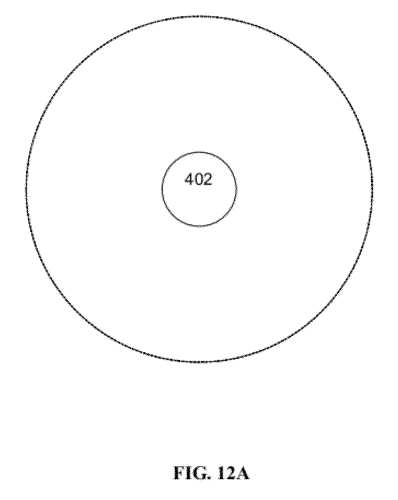

FIG. 11 is a flow diagram illustrating example process 1100 of visualizing performance of a serving cell in relation to a user equipment being served by the serving cell, according to various implementations of the invention. In some implementations of the invention, in an operation 1102, process 1100 may determine first and second values of the serving cell, wherein the first and second values may be based on measurements of first and second attributes of the serving cell.

In some implementations, in an operation 1104, process 1100 may allocate an inner circle portion of a serving cell pie-view display for the first value. In some implementations, the inner circle portion may be substantially circular having a total angle of 360 degrees. In some implementations, the serving cell pie-view display may include the inner circle portion.

In some implementations, in an operation 1106, process 1100 may determine a first angle for the second value and determine a first radius. In some implementations, the first angle may be based on the second value.

In some implementations, in an operation 1108, process 1100 may allocate a first portion of the serving cell pie-view display based on the first angle and the first radius.

In some implementations, in an operation 1110, process 1100 may determine a third value of user equipment 120. In some implementations, the third value may be based on a measurement of a user equipment attribute (i.e., attribute associated with user equipment 120).

In some implementations, in an operation 1112, process 1100 may determine a second angle for the third value and may determine a second radius. In some implementations, the second angle may be based on the third value.

In some implementations, in an operation 1114, process 1100 may allocate a second portion of the serving cell pie-view display based on the second angle and the second radius.

Implementations of the invention may be made in hardware, firmware, software, or any suitable combination thereof. Implementations of the invention may also be implemented as instructions stored on a machine readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method of visualizing performance of network cells relative to one another, the method comprising:
determining a first value of a first network cell and a second value of a second network cell, wherein the first and second values are based on measurements of a first attribute that indicates performance of the first and second network cells;
allocating a first portion of an available cell pie-view display to be occupied based on the first value and a second portion of the available cell pie-view display to be occupied based on the second value,
wherein the available cell pie-view display comprises a substantially circular display having a total angle of 360 degrees and a display radius, and wherein the first portion is based on the first value and the total angle and the second portion is based on the second value and the total angle,
determining a third value of the first network cell and a fourth value of the second network cell, wherein the third and fourth values are based on measurements of a second attribute that indicates performance of the first and second network cells, wherein the second attribute is different than the first attribute;
determining a first radius based on the third value and the display radius and a second radius based on the fourth value and the display radius; and
allocating a third portion of the available cell pie-view display to be occupied based on the first radius and the first portion and a fourth portion of the available cell pie-view display to be occupied based on the second radius and the second portion, wherein the third portion overlaps the first portion and the fourth portion overlaps the second portion, and
wherein the first, second, third and fourth portions provide visualization of measurements of the first and second network cells relative to each other.

2. The method of claim 1, further comprising:
generating the available cell pie-view display based on the first, second, third, and fourth portions.

3. The method of claim 1, wherein allocating a third portion further comprises allocating the third portion to be contained within the first portion and wherein allocating a fourth portion further comprises allocating the fourth portion to be contained with the second portion.

4. The method of claim 1, further comprising:
determining a fifth value of the first network cell and a sixth value of the second network cell, wherein the fifth and sixth values are based on a third attribute that indicates performance of the first and second network cells, wherein the third attribute is different than the first and second attributes;
determining a third radius based on the fifth value and the display radius and a sixth radius based on the sixth value and the display radius; and
allocating a fifth portion of the available cell pie-view display to be occupied based on the third radius and the first portion and a sixth portion of the available cell pie-view display to be occupied based on the fourth radius and the second portion, wherein the fifth portion overlaps the first portion and the sixth portion overlaps the second portion.

5. The method of claim 1, wherein determining a first radius further comprises:
determining a first proportion based on the third value and a common value, wherein the first radius is based on the first proportion and the display radius; and
wherein determining a second radius further comprises: determining a second proportion based on the fourth value and the common value, wherein the second radius is based on the second proportion and the display radius.

6. The method of claim 1, further comprising:
allocating an inner circle region of the available cell pie-view display for data representing a user equipment that is configured to track the first and second network cells.

7. The method of claim 6, wherein the data representing the user equipment comprises one or more of: a status of the user equipment or a mode of the user equipment.

8. The method of claim 6, wherein allocating an inner circle region comprises allocating an inner circle region that does not overlap with the first portion and the second portion.

9. The method of claim 6, further comprising:
allocating a middle circle region of the available cell pie-view display for data representing one or more carriers of the first network cell and the second network cell, wherein the inner circle region does not overlap with the middle circle region.

10. The method of claim 1, further comprising:
allocating a middle circle region of the available cell pie-view display for data representing one or more carriers of the first network cell and the second network cell.

11. The method of claim 1, wherein the available cell pie-view display comprises a first segment that represents a first carrier and a second segment that represents a second carrier, and wherein the first segment comprises the first portion or the second portion and the second segment comprises the first portion or the second portion.

12. The method of claim 1, further comprising:
allocating a color for at least one of: the first portion, the second portion, the third portion, or the fourth portion based on their respective first, second, third, or fourth values.

13. The method of claim 1, further comprising:
allocating a color for at least one of: the first portion, the second portion, the third portion, or the fourth portion based on which of the respective first or second network cells is currently serving the user equipment.

14. The method of claim 1, wherein the first network cell and the second network cell use a first type of radio access technology, the method further comprising:
allocating a first segment of the available cell pie-view display for the first type of radio access technology, wherein the first and second portions are contained within the first segment; and
allocating a second segment of the available cell pie-view display for a second type of radio access technology different from the first type of radio access technology, wherein the second segment of the available cell pie-view display comprises at least one portion of the available cell pie-view display that displays data for at least one cell that uses the second type of radio access technology.

15. A method of visualizing different components of a communications network, the components comprising user equipment, network cells, and carriers of the network cells, the method comprising:
receiving a first value associated with a user equipment, a second value associated with a network cell being tracked by the user equipment, and a third value associated with a carrier of the network cell;
allocating an inner circle region of a pie-view representing a value for one of: the user equipment, the network cell, or the carrier, wherein the pie-view display comprises a substantially circular display having a total angle of 360 degrees;
allocating a middle circle region of the pie-view representing a value for one of: the user equipment, the network cell, or the carrier not displayed in the inner circle; and
allocating an outer circle region of the pie-view representing a value for one of: the user equipment, the network cell, or the carrier not displayed in the inner circle region and the middle circle region, wherein the inner circle region, the middle circle region, and the outer circle region are configured to collectively represent the first, second, and third values.

16. The method of claim 15, wherein the inner circle region is configured to represent the first value, the middle circle region is configured to represent the third value, and the outer circle region is configured to represent the second value.

17. A method of visualizing performance of a serving cell in relation to a user equipment (UE) being served by the serving cell, the method comprising:
determining first and second values of the serving cell, wherein the first and second values are based on measurements of first and second attributes of the serving cell;
allocating an inner circle portion of a serving cell pie-view display for the first value, wherein the inner circle portion is substantially circular having a total angle of 360 degrees, wherein the serving cell pie-view display comprises the inner circle portion;
determining a first angle for the second value and determining a first radius, wherein the first angle is based on the second value;
allocating a first portion of the serving cell pie-view display based on the first angle and the first radius;
determining a third value of the UE, wherein the third value is based on a measurement of a UE attribute;
determining a second angle for the third value and determining a second radius, wherein the second angle is based on the third value; and
allocating a second portion of the serving cell pie-view display based on the second angle and the second radius.

18. The method of claim 17, further comprising:
generating the serving cell pie-view display based on the inner circle region, the first portion, and the second portion.

19. The method of claim 17, further comprising:
allocating a color for at least one of: the inner circle region, the first portion, or the second portion based on their respective first, second, or third values.

20. A user equipment device for visualizing performance of network cells relative to one another, the user equipment device comprising:
one or more processors configured to:
determine a first value of a first network cell and a second value of a second network cell, wherein the first and second values are based on measurements of a first attribute that indicates performance of the first and second network cells;
allocate a first portion of an available cell pie-view display to be occupied based on the first value and a second portion of the available cell pie-view display to be occupied based on the second value,
wherein the available cell pie-view display comprises a substantially circular
display having a total angle of 360 degrees and a display radius, and wherein the first portion is based on the first value and the total angle and the second portion is based on the second value and the total angle,
determine a third value of the first network cell and a fourth value of the second network cell, wherein the third and fourth values are based on measurements of a second attribute that indicates performance of the first and second network cells, wherein the second attribute is different than the first attribute;
determine a first radius based on the third value and the display radius and a second radius based on the fourth value and the display radius; and
allocate a third portion of the available cell pie-view display to be occupied based on the first radius and the first portion and a fourth portion of the available cell pie-view display to be occupied based on the second radius and the second portion, wherein the third portion overlaps the first portion and the fourth portion overlaps the second portion, and
wherein the first, second, third and fourth portions provide visualization of measurements of the first and second network cells relative to each other.

21. The user equipment device of claim 20, wherein the one or more processors are further configured to:
generate the available cell pie-view display based on the first, second, third, and fourth portions.

22. A user equipment device (UE) for visualizing performance of a serving cell in relation to the user equipment device being served by the serving cell, the user equipment device comprising:
one or more processors configured to:
determine first and second values of the serving cell, wherein the first and second values are based on measurements of first and second attributes of the serving cell;
allocate an inner circle portion of a serving cell pie-view display for the first value, wherein the inner circle portion is substantially circular having a total angle of 360 degrees, wherein the serving cell pie-view display comprises the inner circle portion;
determine a first angle for the second value and determine a first radius, wherein the first angle is based on the second value;
allocate a first portion of the serving cell pie-view display based on the first angle and the first radius;
determine a third value of the UE, wherein the third value is based on a measurement of a UE attribute;
determine a second angle for the third value and determine a second radius, wherein the second angle is based on the third value; and
allocate a second portion of the serving cell pie-view display based on the second angle and the second radius.

23. The user equipment device of claim 22, wherein the one or more processors are further configured to:
generate the serving cell pie-view display based on the inner circle region, the first portion, and the second portion.
